(19) United States
(12) Patent Application Publication
(10) Pub. No.: US 2016/0109112 A1
(43) Pub. Date: Apr. 21, 2016

(54) ELECTRONIC DEVICE HAVING INDICATOR LIGHT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YU-MING XIAO, Wuhan (CN); LING-XIN ZENG, Wuhan (CN); HONG ZHENG, Wuhan (CN)

(21) Appl. No.: 14/527,236

(22) Filed: Oct. 29, 2014

(30) Foreign Application Priority Data
Oct. 20, 2014 (CN) 201410556527.2

(51) Int. Cl. F21V 33/00; F21V 23/04; F21V 23/00; F21V 15/01; G06F 1/18

(52) U.S. Cl. CPC F21V 33/0052; F21V 15/01; G06F 1/183; F21V 23/005; F21V 23/04

(57) ABSTRACT

An electronic device includes a housing, an indicator plate, a circuit board, a shading case, and a guiding light member. The indicator plate is attached to an outside surface of the housing and defines a receiving hole. The circuit board is attached in the housing. The indicator light is electrically connected to the circuit board. The shading case and the circuit board together encircle the first indicator light. An end of the first shading case abuts the housing and defines a first through hole. The guiding light member is attached between the first through hole and the first receiving hole. Light emitted from the indicator light passes through the through hole to be transmitted to the receiving hole through the guiding light member.

### CROSS-REFERENCE TO RELATED APPLICATIONS

This application claims priority to Chinese Patent Application No. 201410556527.2, filed on Oct. 20, 2014, the contents of which are incorporated by reference herein.

### FIELD

The present disclosure relates to visual indicators.

### BACKGROUND

Electronic devices include indicator lights to emit light to indicate functions of the electronic device. The indicator lights are received in a receiving space formed by two shells coupled to each other. Light may leak at a gap between the two shells.

### BRIEF DESCRIPTION OF THE DRAWINGS

Implementations of the present technology will now be described, by way of example only, with reference to the attached figures.

FIG. 1 is an isometric view of an electronic device.

FIG. 2 is an exploded isometric view of the electronic device in FIG. 1.

FIG. 3 is similar to FIG. 2, but without a top shell and a bottom shell and a first guiding member and a second guiding member being positioned at an indicator plate.

FIG. 4 is en enlarged view of circle IV of the electronic device in FIG. 2.

FIG. 5 is similar to FIG. 3, but viewed from another angle.

FIG. 6 is a cross-sectional view taken along the line X-X of FIG. 1.

FIG. 7 is an enlarged view of circle XI of the electronic device in FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

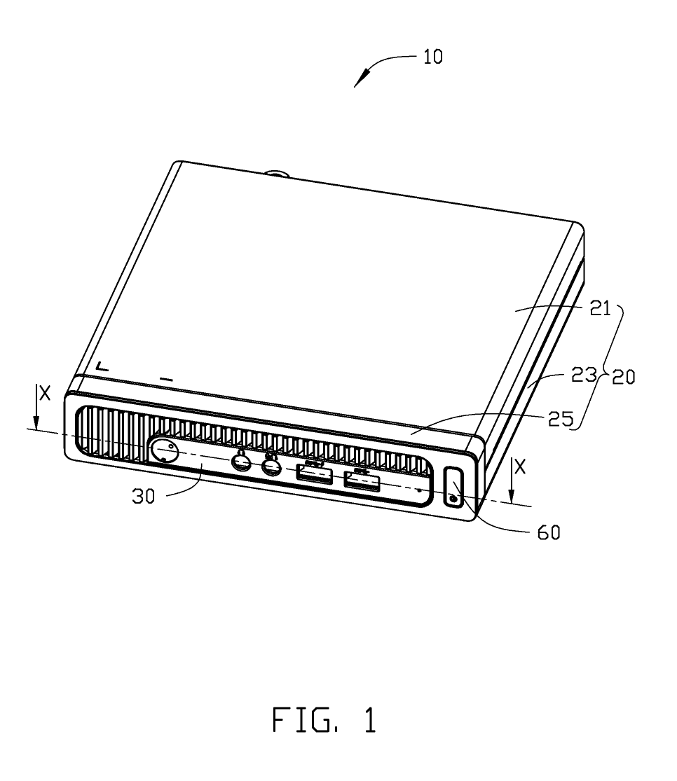

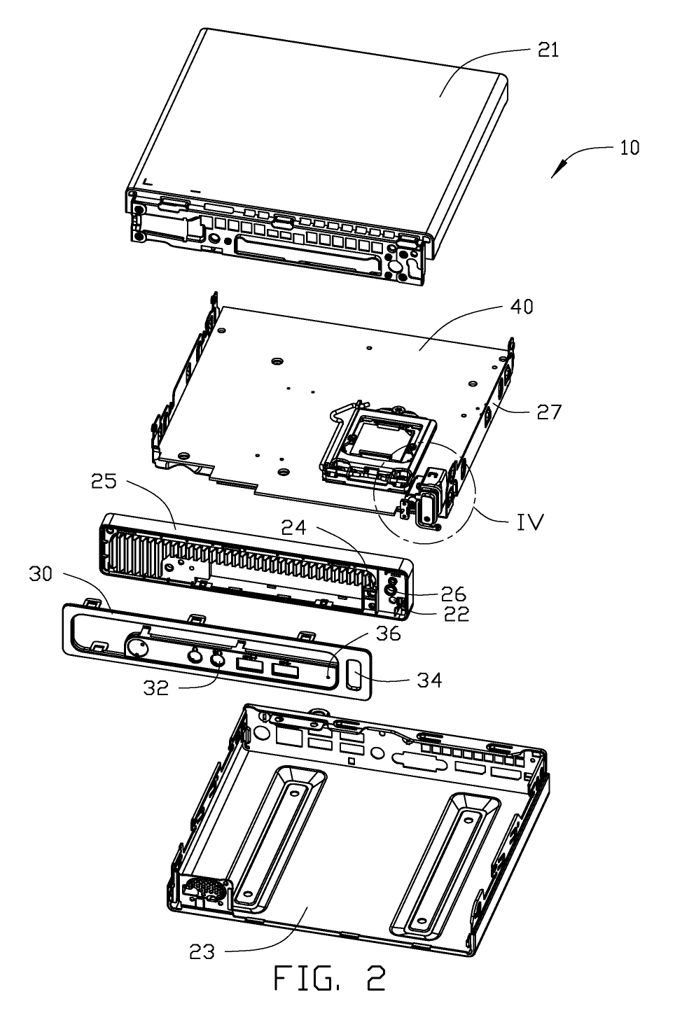

FIGS. 1 and 2 illustrate that an electronic device 10 includes a housing 20, an indicator plate 30, and a circuit board 40. The housing 20 defines a receiving space (not labeled). The indicator plate 30 is attached to an outside surface of the housing 20. The indicator plate 30 defines a number of plug holes 32, a first receiving hole 34, and a second receiving hole 36. The plug holes 32 are configured to receive an earphone or a USB socket. The circuit board 40 is attached in the receiving space. In the embodiment, the electronic device 10 is a host computer.

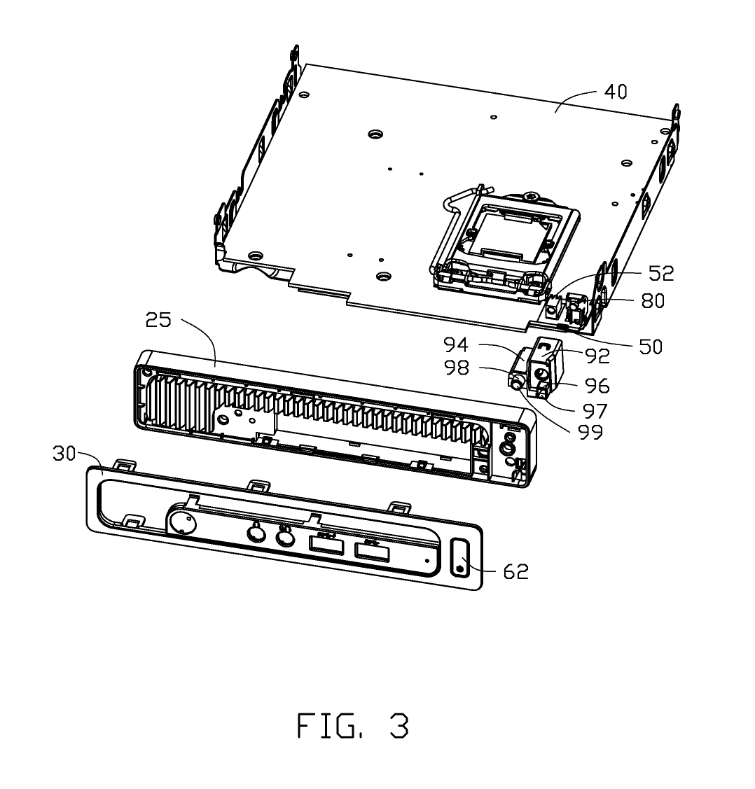

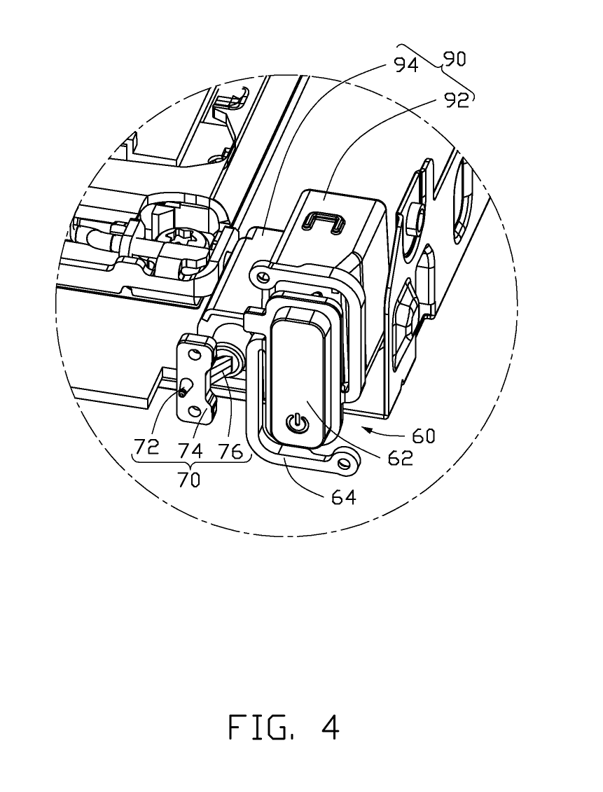

FIGS. 3 and 4 indicate that the electronic device 10 further includes a first indicator light 50, a second indicator light 52, a first guiding light member 60, a second guiding light member 70, a switch 80, and a shading member 90. The first indicator light 50, the second indicator light 52, and the switch 80 are electrically connected to the circuit board 40. The shading member 90 is attached to the circuit board 40. The shading member 90 includes a first shading case 92 and a second shading case 94. The second shading case 94 is arranged beside the first shading case 92 and is attached to an outside surface of the first shading case 92. The first shading case 92 covers the first indicator light 50 and the switch 80 in the first shading case 92. The second shading case 94 covers the second indicator light 52 in the second shading case 94.

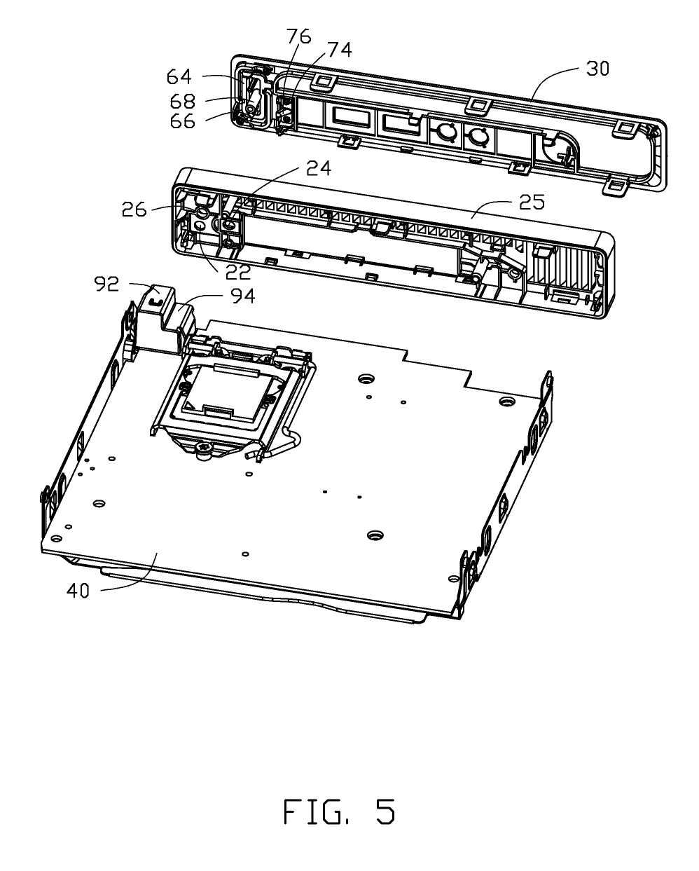

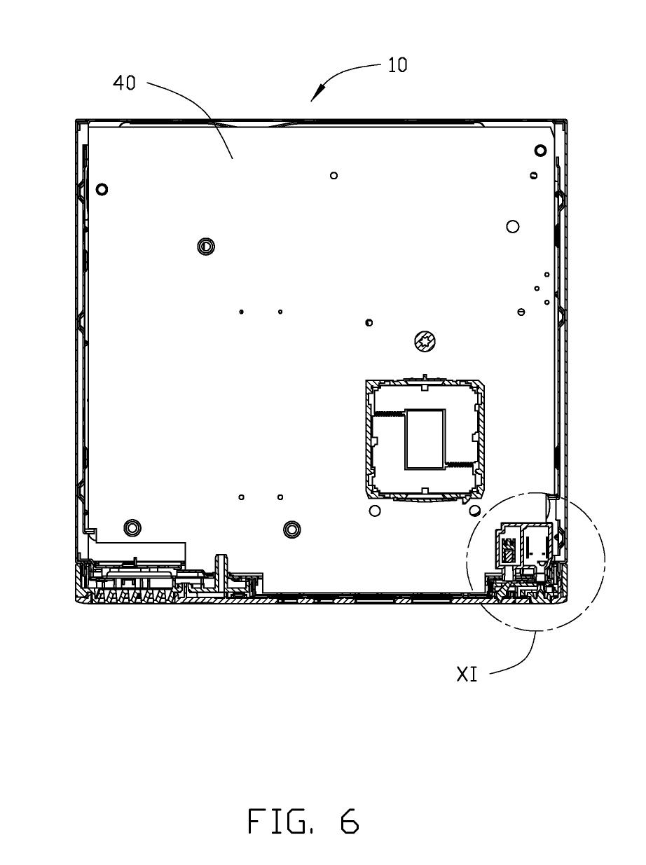

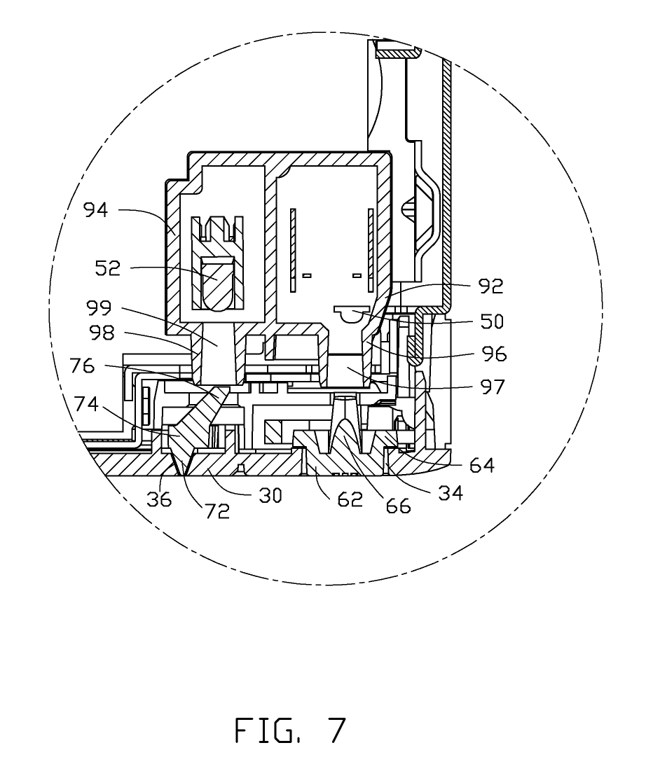

The first shading case 92 includes a first protrusion portion 96 facing the indicator plate 30. The first protrusion portion 96 defines a first through hole 97. The second shading case 95 includes a second protrusion portion 98 facing the indicator plate 30. The second protrusion portion 98 defines a second through hole 99. The first through hole 97 and the second through hole 99 are respectively opposite the first indicator light 50 and the second indicator light 52. FIGS. 5 to 7 illustrate that an end of the first protrusion portion 96 adjacent to the indicator plate 30 and an end of the second protrusion portion 98 adjacent to the indicator plate 30 both touch the housing 20. Thus, light emitted from the first indicator light 50 cannot be emitted out of the first shading case 92 along the radial direction of the first through hole 97 and light from the second indicator light 52 cannot be emitted out of the second shading case 94 along the radial direction of the second through hole 99.

The first guiding light member 60 and the second guiding light member 70 are arranged between the indicator plate 30 and the housing 20. One end of the first guiding light member 60 faces the first through hole 97, and the other end of the first guiding light member 60 is received in the first receiving hole 34. One end of the second guiding light member 70 faces the second through hole 99, and the other end of the second guiding light member 70 is received in the second receiving hole 36.

In the embodiment, the housing 20 defines a first penetrating hole 22, a second penetrating hole 24, and a third penetrating hole 26. The first penetrating hole 22 and the second penetrating hole 24 respectively communicate with the first through hole 97 and the second through hole 99. The first guiding light member 60 includes a first receiving portion 62, a first abutting portion 64, a first guiding portion 66, and a triggering portion 68. The first receiving portion 62 is received in the first receiving hole 34. The triggering portion 68 passes through the third penetrating hole 26 to face the switch 80. The triggering portion 68 is configured to activate the switch 80 when the first receiving portion 62 is pressed. The switch 80 is configured to turn on and turn off the first indicator light 50 and the second indicator light 52. The first abutting portion 64 is between the indicator plate 30 and the housing 20. The first abutting portion 64 is elastic and is configured to reset the first receiving portion 62 when the first receiving portion 62 is relaxed. The first guiding portion 66 is attached to the first receiving portion 62. An end of the first guiding portion away from the first receiving portion 62 is received in the first penetrating hole 22 to guide the light emitted from the first indicator light 50 to the first receiving portion 62. Thus, the light can be seen to indicate that the function of the electronic device 10 indicated by the first indicator light 50 works.

The second indicator light 52 deviates from the second receiving hole 36 at an axial direction of the second receiving hole 36. The second guiding light member 70 includes a second receiving portion 72, a second abutting portion 74, and a second guiding portion 76. The second receiving portion 72 is received in the second receiving hole 36. The second abutting portion 74 is between the indicator plate 30 and the housing 20. The second guiding portion 76 obliquely protrudes from the second abutting portion 74. An end of the second guiding portion away from the indicator light 30 is received in the second penetrating hole 24 to guide the light emitted from the second indicator light 52 to the second receiving hole 36.

In the embodiment, the housing 20 includes a top shell 21, a bottom shell 23, and a front shell 25. The bottom shell 23 is attached to the top shell 21. The front shell 25 is attached to front ends of the top shell 21 and the bottom shell 23. The first abutting portion 64 and the second abutting portion 74 are between the indicator plate 30 and the front shell 25. The circuit board 40 is attached to a supporting plate 27. The supporting plate 27 is attached to bottom shell 23.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. An electronic device with an indicator light comprising:
a housing with an inside surface and an outside surface, the inside surface substantially opposite the outside surface, and the housing substantially enclosing a receiving space for receiving one or more components of the electronic device and defining one or more penetrating holes extending through the housing from the outside surface to the housing receiving space;
an indicator plate having an inner surface and an outer surface, the outer surface substantially parallel to, and opposite of, the inner surface, the indicator plate defining a first receiving hole extending though the indicator plate from the plate outer surface to the plate inner surface, the indicator plate attached to a portion of the outside surface of the housing with the inner plate surface facing the outside housing surface;
a circuit board positioned within the receiving space;
a first shading case connected to the circuit board;
a first indicator light electrically connected to the circuit board and positioned within the first shading case; and
a first light guiding member;
wherein, the first shading case defines a first through hole and the first shading case is positioned within the housing to abut the inner surface of the housing;
wherein, a portion of the first light guiding member is positioned between the outside surface of the housing and the inner surface of the indicator plate; and
wherein, light emitted from the first indicator light may be transmitted through the first light guiding member to outer surface of the indicator surface.

2. The electronic device as claimed in claim 1, wherein the first indicator light is received in the first penetrating hole.

3. The electronic device as claimed in claim 1, wherein the first through hole is aligned with the first indicator light.

4. The electronic device as claimed in claim 1, further comprising a switch electrically connected to the circuit board and configured to turn on/off the first indicator light, the first guiding light member is elastic to be pressed to active the switch.

5. The electronic device as claimed in claim 4, wherein the switch is covered in the first shading case.

6. The electronic device as claimed in claim 1, further comprising a second shading case, a second indicator light covered in the second shading case, the second shading case arranged beside the first shading case and attached to an outside surface of the first shading case.

7. The electronic device as claimed in claim 6, further comprising a second guiding light member, the indicator plate further defining a second receiving hole, an end of the second shading case abutting the housing and defining a second through hole, the second guiding light member attached between the second through hole and the second receiving hole.

8. The electronic device as claimed in claim 7, wherein the second indicator light deviates from the second receiving hole at an axis direction of the second receiving hole, the second guiding light member is obliquely arranged between the second through hole and the second receiving hole.

9. The electronic device as claimed in claim 1, wherein the housing comprises a top shell, a bottom shell and a front shell, the bottom shell is attached to the top shell, the front shell is attached to front ends of the top shell and the bottom shell, the indicator plate is attached to the front shell.

10. The electronic device as claimed in claim 9, wherein a supporting plate is attached to the bottom shell, the circuit board is attached to the supporting plate.

11. An electronic device comprising:
a housing defining a receiving space and a penetrating hole communicating with the receiving space;
an indicator plate attached to an outside surface of the housing and defining a first receiving hole communicating with the penetrating hole;
a circuit board attached in the receiving space;
a first indicator light electrically connected to the circuit board;
a first shading case covering the first indicator light in the first shading case and comprising a first protrusion portion touching the housing, the first protrusion portion defining a first through hole; and
a first guiding light member, one end of the first guiding light member being opposite to the first through hole and another end of the first guiding light member received in the first receiving hole.

12. The electronic device as claimed in claim 11, wherein the first indicator light is received in the first penetrating hole.

13. The electronic device as claimed in claim 11, wherein the first through hole is aligned with the first indicator light.

14. The electronic device as claimed in claim 11, further comprising a switch electrically connected to the circuit board and configured to turn on/off the first indicator light, the first guiding light member is elastic to be pressed to active the switch.

15. The electronic device as claimed in claim 14, where in the switch is covered in the first shading case.

16. The electronic device as claimed in claim 11, further comprising a second shading case, a second indicator light covered in the second shading case, the second shading case arranged beside the first shading case and attached to an outside surface of the first shading case.

17. The electronic device as claimed in claim 16, further comprising a second guiding light member, the indicator plate further defining a second receiving hole, an end of the second shading case abutting the housing and defining a second through hole, the second guiding light member attached between the second through hole and the second receiving hole.

18. The electronic device as claimed in claim 17, wherein the second indicator light deviates from the second receiving hole at an axis direction of the second receiving hole, the second guiding light member is obliquely arranged between the second through hole and the second receiving hole.

19. The electronic device as claimed in claim 11, wherein the housing comprises a top shell, a bottom shell and a front shell, the bottom shell is attached to the top shell, the front shell is attached to front ends of the top shell and the bottom shell, the indicator plate is attached to the front shell.

20. The electronic device as claimed in claim 19, wherein a supporting plate is attached to the bottom shell, the circuit board is attached to the supporting plate.
